(19) United States
(12) Patent Application Publication
(10) Pub. No.: US 2018/0286233 A1
(43) Pub. Date: Oct. 4, 2018

(54) DRIVING ASSISTANCE DEVICE, DRIVING ASSISTANCE METHOD, AND NON-TRANSITORY STORAGE MEDIUM

(71) Applicant: Panasonic Intellectual Property Management Co., Ltd., Osaka (JP)

(72) Inventors: TAKAYUKI SUZUKI, Tokyo (JP); AKITOSHI YAMASHITA, Kanagawa (JP); YUTAKA KANAZAWA, Kanagawa (JP)

(21) Appl. No.: 15/933,440

(22) Filed: Mar. 23, 2018

(30) Foreign Application Priority Data
Mar. 31, 2017 (JP) 2017-070726

(51) Int. Cl. G08G 1/0962; G06K 9/00; B60W 50/14

(52) U.S. Cl. CPC G08G 1/09623; G08G 1/09626; B60W 2050/146; G06K 9/00818; B60W 50/14; G06K 9/00825

(57) ABSTRACT

A driving assistance device includes an image acquisition unit, a signal identification unit, a symbolization unit, and a display controller. The image acquisition unit acquires an image of a viewing field around a vehicle. The image is captured by an on-board camera. The signal identification unit identifies information indicated by a indicator shown in the captured image. The symbolization unit symbolizes the information. The display controller causes the symbolized information to be displayed in a superimposed manner on the captured image or an actual view of a user.

The present application claims the benefit of foreign priority of Japanese patent application 2017-070726 filed on Mar. 31, 2017, the contents all of which are incorporated herein by reference.

### BACKGROUND

### 1. Technical Field

The present disclosure relates to a driving assistance device, a driving assistance method, and a non-transitory storage medium, with which information of an indicator provided along a road or the like, can be easily recognized.

### 2. Background Art

Such driving assistance devices are conventionally known that assist safe driving by capturing, using an on-board camera, traffic lights and road signs (hereinafter referred to as “indicators”) provided along a road or the like and utilizing a result of recognition of information of an indicator (what a signal indicated by a traffic light or a road sign stands for) (e.g., Unexamined Japanese Patent Publication No. 11-306498 and Unexamined Japanese Patent Publication No. 2004-199148). Unexamined Japanese Patent Publication No. 11-306498 discloses a technique for performing automatic driving control of a vehicle based on a result of recognition of the information. Unexamined Japanese Patent Publication No. 2004-199148 discloses a technique of outputting to a user an alarm based on a result of recognition of the information.

### SUMMARY

The present disclosure provides a driving assistance device, a driving assistance method, and a non-transitory storage medium, with which information of an indicator can be easily recognized.

The driving assistance device according to an aspect of the present disclosure includes an image acquisition unit, a signal identification unit, a symbolization unit, and a display controller. The image acquisition unit acquires an image of a viewing field around a vehicle. The image is captured by an on-board camera. The signal identification unit identifies information indicated by an indicator shown in the captured image. The symbolization unit symbolizes the information. The display controller causes the symbolized information to be displayed in a superimposed manner on the captured image or an actual view of a user.

The driving assistance method according to the aspect of the present disclosure includes acquiring an image of a viewing field around a vehicle. The image is captured by an on-board camera. The driving assistance method further includes identifying information indicated by an indicator shown in the captured image. The driving assistance method further includes symbolizing the information. The driving assistance method still further includes causing the symbolized information to be displayed in a superimposed manner on the captured image or an actual view of a user.

The non-transitory storage medium according to the aspect of the present disclosure stores a computer program that causes, when executed by a computer of the driving assistance device, the computer to perform a series of operations. The series of operations to be performed by the computer of the driving assistance device includes acquiring an image of a viewing field around a vehicle. The image is captured by an on-board camera. The series of operations to be performed by the computer of the driving assistance device further includes identifying information indicated by an indicator shown in the captured image. The series of operations to be performed by the computer of the driving assistance device still further includes symbolizing the information. The series of operations to be performed by the computer of the driving assistance device still further includes causing the symbolized information to be displayed in a superimposed manner on the captured image or an actual view of a user.

The present disclosure provides a driving assistance device with which information indicated by an indicator can be easily recognized.

### BRIEF DESCRIPTION OF THE DRAWINGS

FIG. 1 is a block diagram of a driving assistance device according to an exemplary embodiment, the block diagram illustrating a configuration example;

FIG. 2 is a table of symbol information, the table illustrating an example;

FIG. 3 is a flowchart of a driving assistance process performed in an image display system, the flowchart illustrating an example;

FIG. 4A is a view of signal information displayed in a superimposed manner, the view illustrating an example;

FIG. 4B is a view of signal information displayed in a superimposed manner, the view illustrating another example;

FIG. 4C is a view of signal information displayed in a superimposed manner, the view illustrating still another example;

FIG. 5 is a view of signal information displayed in a superimposed manner, the view illustrating still another example;

FIG. 6 is a view of signal information displayed in a superimposed manner, the view illustrating still another example; and

FIG. 7 is a table of symbol information, the table illustrating another example.

### DETAILED DESCRIPTION

Prior to describing an exemplary embodiment of the present disclosure, problems found in a conventional technique will be now briefly described herein. How well information of an indicator is recognized differs depending on a surrounding environment during driving and a visual salience of a user. For example, an indicator might not be well seen under a particular condition such as a darker environment in which rain or snow falls or a brighter environment being exposed to direct sunlight. For example, persons with color-vision deficiency, who are not able to well recognize a color of a signal light being lit, have to rely on a position of the signal light being lit. The techniques disclosed in Unexamined Japanese Patent Publication No. 11-306498 and Unexamined Japanese Patent Publication No. 2004-199148 do not well support a person with color-vision deficiency to recognize information.

On the other hand, Unexamined Japanese Utility Model Publication No. 3046897 discloses a traffic light that presents a signal with a simple graphic. The technique allows a user to easily recognize information with a shape of a graphic. Replacing to such traffic lights from existing ones is however unrealistic in terms of facility investments, and thus the traffic lights are not yet widely prevailed.

The exemplary embodiment of the present disclosure will now be described herein in detail with reference to the drawings.

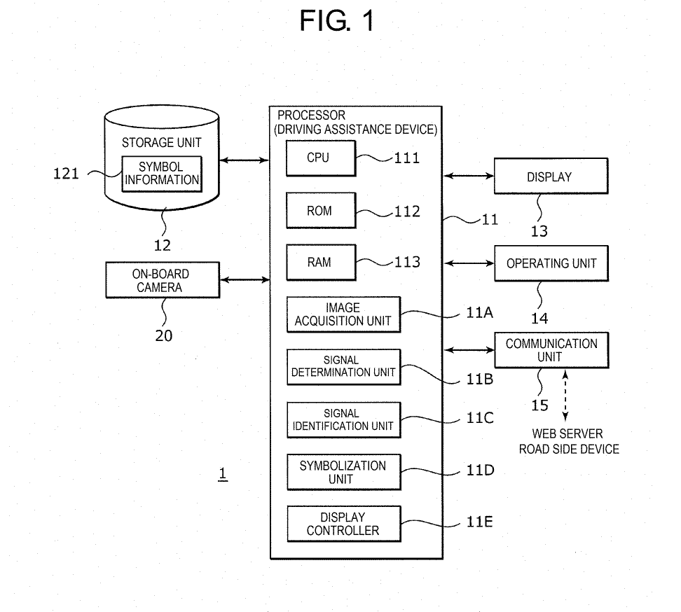

FIG. 1 is a block diagram of image display system 1 according to the exemplary embodiment, the block diagram illustrating a configuration example. Image display system 1 is mounted on a vehicle that travels on a road, and is used to check a front viewing field of the vehicle. Processor 11 of image display system 1 functions as a driving assistance device according to the present disclosure. In other words, processor 11 assists a user to easily recognize information indicated by an indicator lying in front of the vehicle.

An indicator denotes a traffic light or a road sign, for example. Information indicated by an indicator denotes a signal or a sign presented by the traffic light or the road sign. The exemplary embodiment describes how a user is assisted to recognize information indicated by an indicator.

As illustrated in FIG. 1, image display system 1 includes processor 11, storage unit 12, display 13, operating unit 14, communication unit 15, and on-board camera 20, for example.

On-board camera 20 is provided on a front (e.g., front grille) of the vehicle, for example, (hereinafter referred to as “front camera 20”). Front camera 20 includes an imaging element such as a charge-coupled device (CCD) image sensor or a complementary metal oxide semiconductor (CMOS) image sensor. An electric signal indicative of an image of a front viewing field is photo-electric converted by the imaging element and sent to processor 11 via a wireless communication or a wired communication.

Display 13 is a display such as a liquid crystal display or an organic electro luminescence (EL) display. Operating unit 14 is an input device with which a user is able to enter characters and numerals, for example. A flat panel display with a touch panel may be used to configure display 13 and operating unit 14. Display 13 and operating unit 14 are used by a user of image display system 1 to enter a visual salience of the user, as well as to enter information on a country in which the user usually drives a vehicle (e.g., user's home country), for example. Display 13 displays an image actually captured by front camera 20. An actually captured image may be an image obtained by variously processing an image captured by on-board camera 20. A variously processed image may be an image that is rotation and distortion corrected or that is sharpened or from which snow, fog, or rain, for example, is removed.

Processor 11 includes central processing unit (CPU) 111 served as a computing/controlling device, read only memory (ROM) 112 served as a main memory device, and random access memory (RAM) 113, for example. ROM 112 stores a basic program called as a basic input output system (BIOS) and basic setting data. CPU 111 reads from ROM 112 a program in accordance with processing being performed, deploys the program in RAM 113, and runs the deployed program to centrally control how blocks of image display system 1 are operated, for example.

Storage unit 12 is an auxiliary memory device such as a hard disk drive (HDD) or a solid state drive (SSD). Storage unit 12 may be a disc drive that drives an optical disc such as a compact disc (CD) or a digital versatile disc (DVD) or a magneto-optical disk (MO) to read and write information. For example, storage unit 12 may be a universal serial bus (USB) memory or a memory card such as a secure digital (SD) card. Storage unit 12 stores symbol information 121 in which information indicated by a traffic light and signal information are associated with each other.

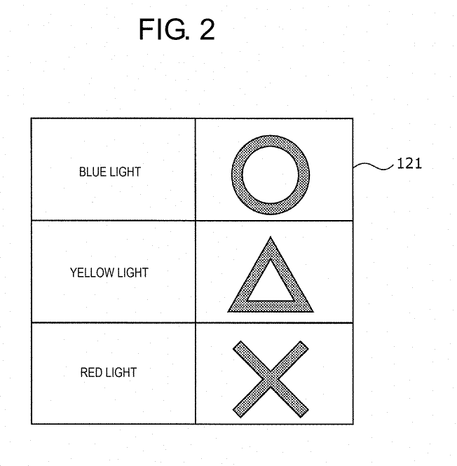

FIG. 2 illustrates an example of symbol information 121. In the example illustrated in FIG. 2, blue “◯” graphic data is registered in association with a traffic light being lit in blue (hereinafter referred to as “blue light”), yellow “Δ” graphic data is registered in association with the traffic light being lit in yellow (hereinafter referred to as “yellow light”), and red “x” graphic data is registered in association with the traffic light being lit in red (hereinafter referred to as “red light”). These pieces of graphic data correspond to symbolized signal information.

Signal information may include character data as long as a user is able to easily recognize if a traffic light is lit in blue, yellow, or red. Signal information may be colored or monochrome. With colored signal information, a user is able to recognize, with not only a shape, but also a color, information indicated by a traffic light.

Communication unit 15 is a communication interface such as a network interface card (NIC) or a modulator-demodulator (MODEM). Processor 11 sends and receives various kinds of information, via communication unit 15, to and from a server (e.g., web server of a weather information providing service) connected to the Internet. Communication unit 15 may include an interface for short range communications (e.g., dedicated short range communication, or DSRC). In this case, processor 11 can acquire information indicative of information indicated by a traffic light from a road side device (not shown) via communication unit 15.

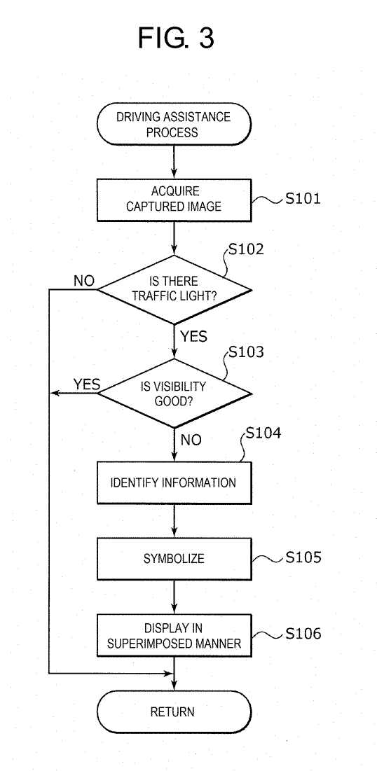

Processor 11 runs a driving assistance program to function as image acquisition unit 11A, signal determination unit 11B, signal identification unit 11C, symbolization unit 11D, and display controller 11E. The functionality is described later in detail with reference to the flowchart of FIG. 3. The driving assistance program is stored in ROM 112, for example. The driving assistance program is provided via a computer-readable portable storage medium (e.g., an optical disc, a magneto-optical disk, or a memory card) that stores the program, for example. For example, the driving assistance program may otherwise be downloaded, via a network, from a server that stores the program.

FIG. 3 is a flowchart of a driving assistance process performed by processor 11, the flowchart illustrating an example. This process is achieved when a power source (engine or motor) of a vehicle starts, image display system 1 starts, and CPU 111 calls and runs the driving assistance program stored in ROM 112, for example.

In step S101, processor 11 (works as image acquisition unit 11A) acquires a single-frame image captured by front camera 20. Later steps will be performed per frame, or may be performed per a plurality of frames.

In step S102, processor 11 (works as signal determination unit 11B) analyzes the captured image to determine whether there is a traffic light shown in the captured image. A known image recognition technology (e.g., pattern matching) can be utilized for this step. When it is determined that there is a traffic light shown in the captured image (“YES” in step S102), step S103 starts. When it is determined that there is no traffic light shown in the captured image (“NO” in step S102), the frame will no longer undergo later steps.

In step S103, processor 11 (signal determination unit 11B works as a visibility determination unit) determines a visibility of the traffic light shown in the captured image, that is, if the traffic light shown in the captured image can be well seen. In this step, it may be determined if the captured image can be seen as a whole or if each of traffic lights shown in the captured image can be well seen. Processor 11 analyzes the captured image to determine if the traffic light can be well seen, for example. For example, processor 11 may determine if the traffic light can be well seen based on weather information acquired, via communication unit 15, from a web server. For example, it is determined that the traffic light cannot be well seen when rain or snow falls. When a user is set as a person with color-vision deficiency, it may be determined that a traffic light cannot be well seen regardless of how sharp a captured image is or of weather information. When it is determined that the traffic light cannot be well seen (“NO” in step S103), step S104 starts. When it is determined that the traffic light can be well seen (“YES” in step S103), it is regarded that the user is able to easily recognize information indicated by the traffic light, and thus the frame will no longer undergo later steps.

In step S104, processor 11 (works as signal identification unit 11C) identifies information indicated by the traffic light shown in the captured image. Specifically, processor 11 identifies whether the traffic light is lit in blue, yellow, or red. Processor 11 utilizes a known color recognition technology, analyzes a captured image, and identifies information indicated by a traffic light, for example. For example, processor 11 may identify information indicated by a traffic light based on indication information acquired, via communication unit 15, from a road side device.

In step S105, processor 11 (works as symbolization unit 11D) symbolizes the information indicated by the traffic light. Specifically, processor 11 refers to symbol information 121 stored in storage unit 12 (see FIG. 2) to read graphic data (signal information) associated with the information indicated by the traffic light. For example, when the traffic light is lit in blue, “◯” graphic data is read. For example, when the traffic light is lit in red, “x” graphic data is read.

In step S106, processor 11 (works as display controller 11E) causes the symbolized signal information to be displayed in a superimposed manner on the captured image (actually captured image). Specifically, processor 11 causes display 13 to display, with the symbolized signal information superimposed, the actually captured image based on data of the captured image acquired in step S101.

As described above, the frame has undergone the steps, and then a next frame undergoes the driving assistance process. In step S102, when a captured image includes a plurality of traffic lights, each of the traffic lights undergo steps S104 to S106.

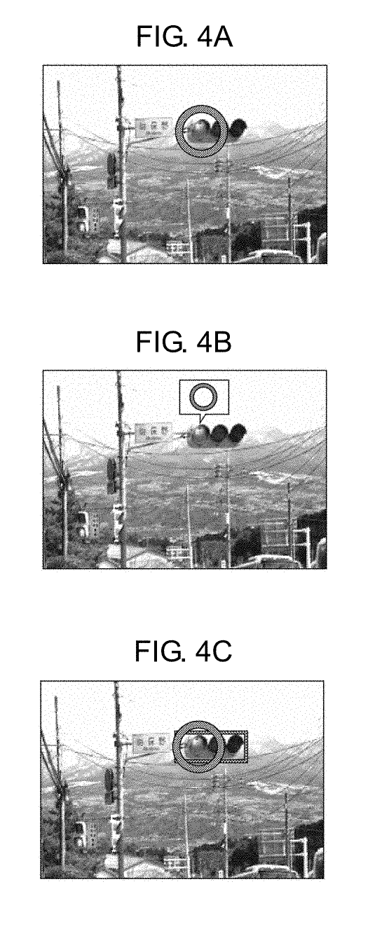

FIGS. 4A to 4C are views of signal information displayed in a superimposed manner, the views illustrating examples. In FIG. 4A, a traffic light is displayed with a piece of signal information (“◯” graphic) indicative of blue light superimposed on a region. In FIG. 4B, the traffic light is displayed with another piece of signal information indicative of blue light superimposed on an adjacent region.

As described above, a traffic light may be displayed with signal information superimposed on a region or an adjacent region. As illustrated in FIG. 4C, the traffic light may be displayed in a highlighted manner with a frame superimposed on the subject traffic light. With such signal information displayed in a superimposed manner, a user is able to easily recognize information indicated by a traffic light. Even when a user is a person with color-vision deficiency, displaying information indicated by a traffic light with symbolized signal information allows the user to easily recognize the information.

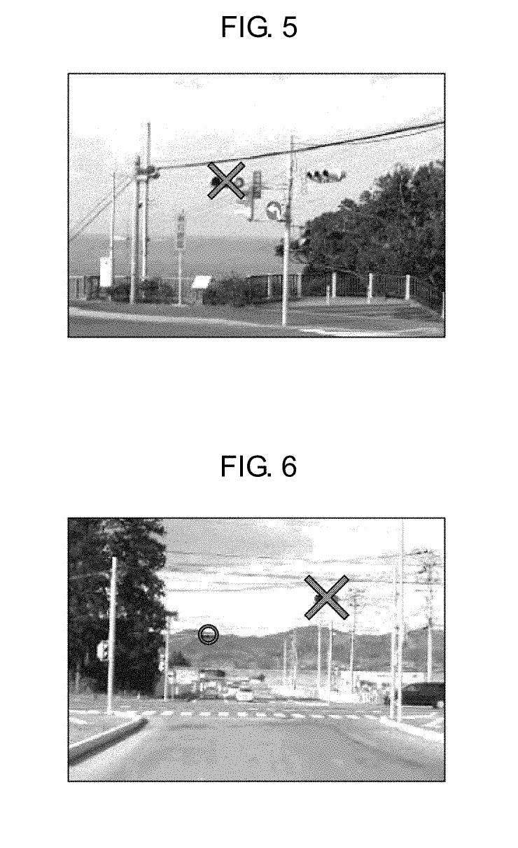

FIG. 5 is a view of signal information displayed in a superimposed manner, the view illustrating still another example. FIG. 5 displays only signal information (“x” graphic) indicative of information indicated by a traffic light for a travel lane, but does not display signal information indicative of information indicated by a traffic light for a lane that crosses the travel lane.

As described above, processor 11 (display controller 11E) may cause only signal information of a traffic light, to which a user has to refer, to be displayed. This prevents pieces of signal information displayed in a superimposed manner from scattering, but allows a user to recognize information indicated by a subject traffic light. A traffic light to which a user has to refer denotes a traffic light provided for a travel lane on which the user drives his or her vehicle, for example. For example, a traffic light with a right-turn indicator, which can be found when a user drives his or her vehicle on a right-turn lane, is regarded as a traffic light to which the user has to refer.

FIG. 6 is a view of signal information displayed in a superimposed manner, the view illustrating still another example. In FIG. 6 in which there is a plurality of traffic lights for a travel lane, signal information (“x” graphic) indicative of a meaning of a traffic light that is close to a vehicle driven by a user is shown greater in size for easy recognition than signal information (“◯” graphic) indicative of a meaning of a traffic light that is distant from the vehicle. As described above, when there is a plurality of traffic lights to which a user has to refer, a display mode of signal information (e.g., size, color, and frame highlight) may be changed in accordance with priority. In FIG. 6, priority is set in an order of proximity to a vehicle.

This makes the user possible to know which traffic light is the most important, preventing the user from erroneously recognizing another signal even when there is a plurality of traffic lights. If pieces of signal information displayed in a superimposed manner scatter, and therefore a user is not able to well recognize information indicated by the most important traffic light, the display may not be superimposed with pieces of information on signals of traffic lights with lower priority.

As described above, processor 11 (driving assistance device) of image display system 1 includes image acquisition unit 11A, signal identification unit 11C, symbolization unit 11D, and display controller 11E. Image acquisition unit 11A acquires an image captured by on-board camera 20 of a front viewing field of a vehicle. Signal identification unit 11C identifies information (signal meaning) indicated by a traffic light (traffic signal) shown in the captured image. Symbolization unit 11D symbolizes the information indicated by the traffic light. Display controller 11E causes symbolized signal information to be displayed in a superimposed manner on the captured image.

A driving assistance method according to the exemplary embodiment includes acquiring an image captured by on-board camera 20 of a front viewing field of a vehicle (step S101 of FIG. 3). The driving assistance method further includes identifying information (signal meaning) indicated by a traffic light (traffic signal) shown in the captured image (step S104). The driving assistance method further includes symbolizing the information indicated by the traffic light (step S105). The driving assistance method further includes causing symbolized signal information to be displayed in a superimposed manner on the captured image (step S106).

A non-transitory storage medium according to the exemplary embodiment stores a computer program that causes, when executed by processor 11 (computer), processor 11 to perform a series of operations. The series of operations to be performed by processor 11 (computer) includes acquiring an image captured by on-board camera 20 of a front viewing field of a vehicle (step S101 of FIG. 3). The series of operations to be performed by processor 11 (computer) further includes identifying information (signal meaning) indicated by a traffic light (traffic signal) shown in the captured image (step S104). The series of operations to be performed by processor 11 (computer) further includes symbolizing the information indicated by the traffic light (step S105). The series of operations to be performed by processor 11 (computer) further includes causing symbolized signal information to be displayed in a superimposed manner on the captured image (step S106).

Displaying information indicated by a traffic light with symbolized signal information allows a user to easily recognize, with at least a shape of the signal information, the information of the traffic signal. The user is thus assisted for safe driving, reducing risk of traffic accidents. The benefits of the present disclosure are highly applicable when a traffic light cannot be well seen due to rain, snow, or direct sunlight or when a user is a person with color-vision deficiency.

Although the present disclosure has been specifically described above based on the exemplary embodiment, the present disclosure is not limited to the above exemplary embodiment, and can be modified without departing from the gist of the present disclosure.

The exemplary embodiment has described when a user is assisted to recognize information indicated by a traffic light. The present disclosure is however applicable to when a user is assisted to recognize a meaning of a traffic sign, for example.

In the exemplary embodiment, signal information is only displayed when a traffic light cannot be well seen. Signal information may however always be displayed regardless of whether a traffic light can be well seen, for example.

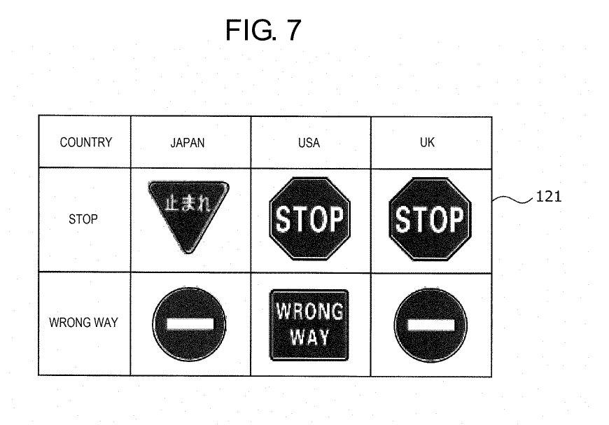

A traffic light or a road sign representing an identical meaning may sometimes differ in a display mode depending on a country (see FIG. 7). In response to this, information may be symbolized based on country information set by a user. For a road sign, as illustrated in FIG. 7, sign data corresponding to a country is registered in association with a meaning of the road sign. When a captured image shows a road sign, a meaning of the road sign is identified, and sign data to be displayed is selected and read based on the set country information and the identified meaning. Displaying signal information in a mode that is familiar to a user allows the user to easily recognize a meaning of a road sign.

If, in a country set by a user, there is no indicator corresponding to information indicated by an indicator which has been captured by an on-board camera, the information may be displayed in a symbolized manner for easy recognition by the user.

In the exemplary embodiment, signal information is displayed in a superimposed manner on an actually captured image. The signal information may however be directly superimposed in a view (actual view) of a user using a head-up display (HUD).

The present disclosure has been achieved with the exemplary embodiment that allows processor 11 (computer) to function as image acquisition unit 11A, signal determination unit 11B, signal identification unit 11C, symbolization unit 11D, and display controller 11E. Some or all of the functionality can be achieved by using electronic circuits such as a digital signal processor (DSP), an application specific integrated circuit (ASIC), or a programmable logic device (PLD).

The exemplary embodiment has employed a single on-board camera. Two or more on-board cameras may however be used. Two or more on-board cameras allow a distance to an object to be easily recognized, as well as allow a three dimensional display.

In the exemplary embodiment, the on-board camera is a front camera that captures a front viewing field of a vehicle. This is however merely an example. An on-board camera may be a camera that captures a viewing field around a vehicle, such as a rear camera that captures a rear viewing field of a vehicle.

It should be construed that the exemplary embodiment disclosed herein is illustrative in all aspects, and is not restrictive. The scope of the present disclosure is represented by the scope of the claims and not by the above description, and it is intended that all modifications within the sense and scope equivalent to the claims are involved in the scope of the present disclosure.

The present disclosure is advantageously applicable to driving assistance technologies for assisting recognition of information indicated by an indicator provided along a road, for example.

What is claimed is:

1. A driving assistance device comprising:
an image acquisition unit configured to acquire an image of a viewing field around a vehicle, the image being captured by an on-board camera;
a signal identification unit configured to identify information indicated by an indicator shown in the captured image;
a symbolization unit configured to symbolize the information; and
a display controller configured to cause the symbolized information to be displayed in a superimposed manner on the captured image or an actual view of a user.

2. The driving assistance device according to claim 1, further comprising a visibility determination unit configured to determine how well the indicator can be seen,
wherein the display controller causes the information to be displayed based on a result of determination by the visibility determination unit.

3. The driving assistance device according to claim 1, wherein the display controller causes only the information of the indicator to which the user has to refer, to be displayed.

4. The driving assistance device according to claim 3, wherein, when there are a plurality of indicators to which the user has to refer, the display controller causes display modes of pieces of the symbolized information of the indicators to be changed in accordance with priorities of the indicators.

5. The driving assistance device according to claim 4, wherein the display controller causes the pieces of the symbolized information of the indicators to be displayed in a display mode allowing symbolized information of an indicator nearer to the vehicle to be more easily recognized by the user.

6. The driving assistance device according to claim 1, wherein the symbolization unit symbolizes the information based on country information set by the user.

7. The driving assistance device according to claim 1, wherein the signal identification unit analyzes the captured image to identify the information.

8. The driving assistance device according to claim 1, wherein the signal identification unit identifies the information by road-vehicle communication with a road side device configured to provide the information.

9. A driving assistance method comprising:
acquiring an image of a viewing field around a vehicle, the image being captured by an on-board camera;
identifying information indicated by an indicator shown in the captured image;
symbolizing the information; and
causing the symbolized information to be displayed in a superimposed manner on the captured image or an actual view of a user.

10. A non-transitory storage medium that stores a driving assistance program that causes, when executed by a computer of a driving assistance device, the computer to perform a series of operations comprising:
acquiring an image of a viewing field around a vehicle, the image being captured by an on-board camera;
identifying information indicated by an indicator shown in the captured image;
symbolizing the information; and
causing the symbolized information to be displayed in a superimposed manner on the captured image or an actual view of a user.
